(19) United States
(12) Patent Application Publication
(10) Pub. No.: US 2024/0104178 A1
(43) Pub. Date: Mar. 28, 2024

(54) INFORMATION PROCESSING APPARATUS, INFORMATION PROCESSING METHOD, MATCHING SYSTEM, PROGRAM, AND STORAGE MEDIUM

(71) Applicant: NEC Corporation, Minato-ku Tokyo (JP)

(72) Inventor: Toshiyuki SASHIHARA, Tokyo (JP)

(73) Assignee: NEC Corporation, Minato-ku Tokyo (JP)

(21) Appl. No.: 17/637,977

(22) PCT Filed: Nov. 19, 2021
(86) PCT No.: PCT/JP2021/042538

§ 371 Date: Feb. 24, 2022

(30) Foreign Application Priority Data
Feb. 18, 2021 (JP) 2021-023824

(51) Int. Cl. G06F 21/32; G06V 40/50

(52) U.S. Cl. CPC G06F 21/32; G06V 40/50; G06F 2221/2117

(57) ABSTRACT

A disclosed information processing apparatus includes: a similarity calculation unit that, for each of a plurality of registration candidate data each including biometric information on a single person, calculates a similarity to test data including the biometric information on the person of interest; and a registration data selection unit that selects, as registration data to be registered in a data storage unit for matching the person of interest, registration candidate data whose similarity to the test data is ranked high out of the plurality of registration candidate data.

### TECHNICAL FIELD

The present disclosure relates to an information processing apparatus, an information processing method, a matching system, a program, and a storage medium.

### BACKGROUND ART

Identity authentication technologies using various types of biometric information, such as face authentication using a face image or iris authentication using an iris image have been proposed. Patent Literature 1 discloses an identity authentication system using face data and voice data. Further, Patent Literature 2 discloses an authentication apparatus that performs authentication using a plurality of matching images. Patent Literature 3 discloses a technology for registering suitable biometric information in accordance with a temporal change of biometric information.

### CITATION LIST

### Patent Literature

PTL 1: Japanese Patent Application Publication No. 2000-148985

PTL 2: Japanese Patent Application Publication No. 2008-059533

PTL 3: Japanese Patent Application Publication No. 2010-231320

### SUMMARY OF INVENTION

### Technical Problem

In biometric authentication using image data, determination as to whether or not a person included in an acquired image is the same person as a person registered in a database is performed through matching of the acquired image with an image registered in the database. Thus, images of persons to be authenticated are registered in advance in a database of an authentication apparatus. In such a situation, if registration images are of low quality, it will be difficult to discriminate a person from others and cause erroneous authentication, and it is thus desirable to register images of as high quality as possible in a database.

Although it is desirable to automatically select registration images to facilitate smooth registration of an image of a person in question, a method for automatically selecting a registration image suitable for biometric matching out of a plurality of registration candidate images has not been proposed so far.

An example object of the present disclosure is to provide an information processing apparatus, an information processing method, a matching system, a program, and a storage medium that can automatically select biometric information data suitable for matching of biometric information out of registration candidate data.

### Solution to Problem

According to one example aspect of the present disclosure, provided is an information processing apparatus including a similarity calculation unit that, for each of a plurality of registration candidate data each including biometric information on a single person, calculates a similarity to test data including the biometric information on the person; and a registration data selection unit that selects, as registration data to be registered in a data storage unit for matching the person, registration candidate data whose similarity to the test data is ranked high out of the plurality of registration candidate data.

According to another example aspect of the present disclosure, provided is a matching system including: a data acquisition device that acquires biometric information data on a person; a storage device in which a plurality of biometric information data on a plurality of persons are registered; and an information processing apparatus having a similarity calculation unit that calculates a similarity between the biometric information data acquired by the data acquisition device and the plurality of biometric information data registered in the storage device and a matching unit that, based on the similarity, determines whether or not a person indicated by the biometric information data acquired by the data acquisition device is a person registered in the storage device, the similarity calculation unit is further configured to calculate a similarity to test data including biometric information on the person for each of a plurality of registration candidate data each including biometric information on a single person, and the information processing apparatus further has a registration data selection unit that selects registration data to be registered in the storage device for matching the person out of the plurality of registration candidate data based on the similarity of each of the plurality of registration candidate data to the test data and a similarity to each of the plurality of biometric information data on the plurality of persons.

According to yet another example aspect of the present disclosure, provided is a program that causes a computer to function as: a unit that, for each of a plurality of registration candidate data each including biometric information on a single person, calculates a similarity to test data including the biometric information on the person; and a unit that selects, as registration data to be registered in a data storage unit for matching the person, registration candidate data whose similarity to the test data is ranked high out of the plurality of registration candidate data.

### BRIEF DESCRIPTION OF DRAWINGS

FIG. 1 is a block diagram illustrating a general configuration of an information processing apparatus according to a first example embodiment.

FIG. 2 is a flowchart illustrating an information processing method according to the first example embodiment.

FIG. 3 is a diagram illustrating an example of application of the information processing method according to the first example embodiment.

FIG. 4 is a block diagram illustrating an example of a hardware configuration of the information processing apparatus according to the first example embodiment.

FIG. 5 is a flowchart illustrating an information processing method according to a second example embodiment.

FIG. 6 is a diagram illustrating an example of application of the information processing method according to the second example embodiment.

FIG. 7 is a flowchart illustrating an information processing method according to a third example embodiment.

FIG. 8 is a diagram illustrating an example of application of the information processing method according to the third example embodiment.

FIG. 9 is a flowchart illustrating an information processing method according to a fourth example embodiment.

FIG. 10 is a diagram illustrating an example of application of the information processing method according to the fourth example embodiment.

FIG. 11 is a block diagram illustrating a general configuration of a matching system according to a fifth example embodiment.

FIG. 12 is a block diagram illustrating a general configuration of an information processing apparatus according to a sixth example embodiment.

FIG. 13 is a block diagram illustrating a general configuration of a matching system according to a seventh example embodiment.

### DESCRIPTION OF EMBODIMENTS

### First Example Embodiment

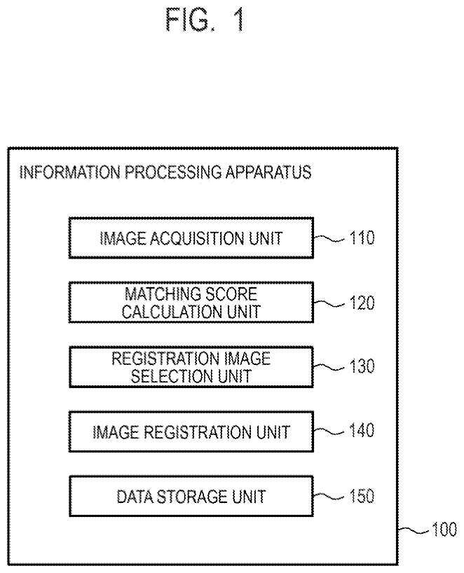

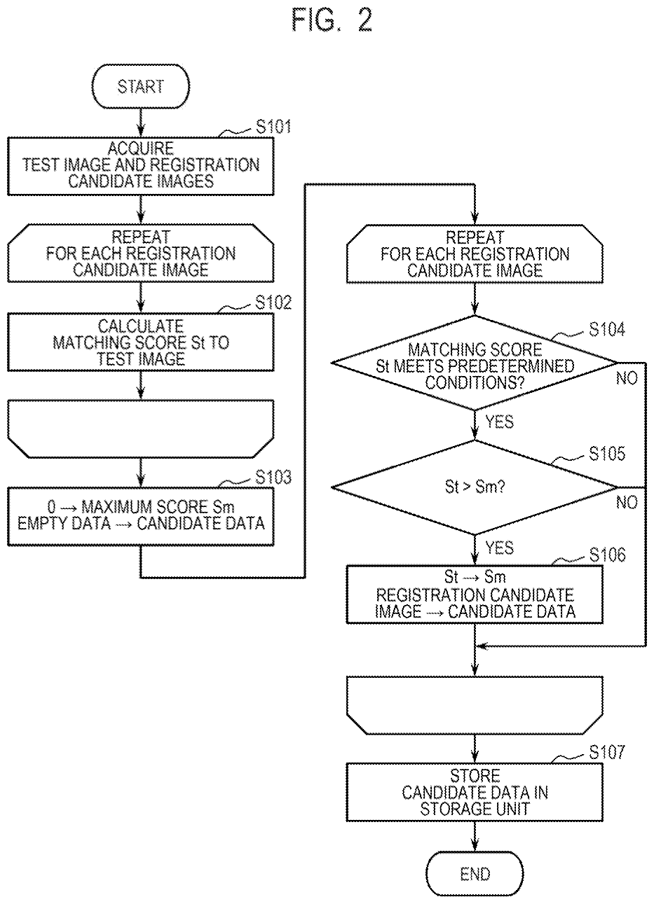

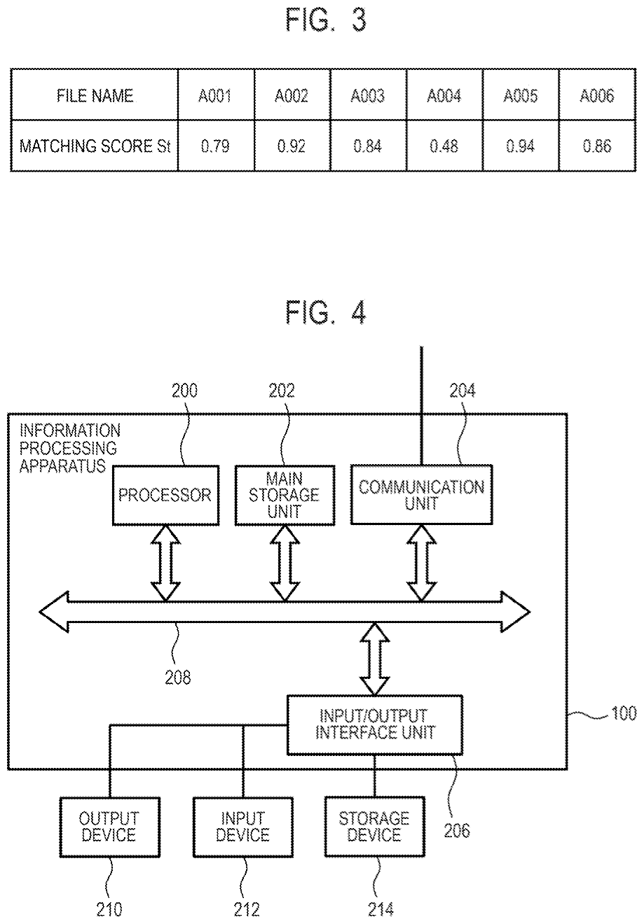

An information processing apparatus and an information processing method according to a first example embodiment will be described with reference to FIG. 1 to FIG. 4. FIG. 1 is a block diagram illustrating a general configuration of the information processing apparatus according to the present example embodiment. FIG. 2 is a flowchart illustrating the information processing method according to the present example embodiment. FIG. 3 is a diagram illustrating an example of application of the information processing method according to the present example embodiment. FIG. 4 is a block diagram illustrating an example of a hardware configuration of the information processing apparatus according to the present example embodiment.

First, an example of the configuration of the information processing apparatus according to the present example embodiment will be described with reference to FIG. 1.

An information processing apparatus 100 according to the present example embodiment has a function of selecting an image suitable for identifying a person from others out of a plurality of images including the same person (registration candidate images) and registering the selected image in a database. As illustrated in FIG. 1, the information processing apparatus 100 may include an image acquisition unit 110, a matching score calculation unit 120, a registration image selection unit 130, an image registration unit 140, and a data storage unit 150.

The image acquisition unit 110 is a function block having a function of acquiring image data representing biometric information from an external device (not illustrated) such as an image acquisition device, for example. The image data representing biometric information may be, for example, face image data, fingerprint image data, vein image data, iris image data, or the like. The image acquisition device may be a capturing device having a function of acquiring a static image or a moving image when an image to be acquired is a face image, for example.

The matching score calculation unit 120 is a function block having a function of matching each of a plurality of registration candidate images acquired by the image acquisition unit 110 with a test image and calculating a matching score representing the similarity to the test image. The registration candidate image is an image acquired by the image acquisition unit 110. The test image is an image commonly used as a matching image when a matching score is calculated for each of the registration candidate images.

The registration image selection unit 130 is a function block having a function of selecting an image suitable for identifying a person from others out of a plurality of registration candidate images based on a matching score calculated by the matching score calculation unit 120.

The image registration unit 140 is a function block having a function of registering a registration candidate image selected by the registration image selection unit 130 in the data storage unit 150 as registration data.

The data storage unit 150 is a function block having a function of holding a registration candidate image selected by the registration image selection unit 130 (registration data). Note that the data storage unit 150 may be a part of the information processing apparatus 100 as illustrated in FIG. 1 or may be a separate device (storage device) provided outside the information processing apparatus 100.

Next, an information processing method using the information processing apparatus 100 according to the present example embodiment will be described with reference to FIG. 2 and FIG. 3 while illustrating in more detail the function of each unit described above. Note that, although a case where image data including a face image is used as biometric information data on a person to be registered will be described here as an example, the same applies to a case where another biometric information data is used. Known schemes in accordance with the type of biometric information data can be applied to calculation of a matching score.

First, the image acquisition unit 110 acquires, from an external device, a plurality of image data including face images of a person to be registered. In the present example embodiment, one of the plurality of image data acquired in such a way is used as a test image, and a plurality of remaining images are used as registration candidate images (step S101).

The plurality of registration candidate images may be images captured by a capturing device forming a part of a matching system, for example. The test image may be one of the images acquired in the same manner as for the plurality of registration candidate images or may be a separately prepared face image of a person to be registered. The plurality of registration candidate images may include images captured under different capturing conditions such as brightness of lighting, for example. When a matching score described later significantly affects a capturing condition, it is expected that acquisition of a plurality of images with different capturing conditions facilitates acquisition of an image more suitable for a matching process.

Note that, when a test image is selected out of a plurality of registration candidate images, it is preferable that the test image be fixed to a particular one image in terms of equitable comparison between registration candidate images. However, when it can be considered that a change of the test image less affects the result, the test image is not necessarily required to be fixed to one image, and any registration candidate image selected out of remaining registration candidate images except for a registration candidate image being evaluated may be used as a test image.

Note that, since it is intended for initial registration of a person image in the present example embodiment, it is desirable to select the plurality of registration candidate images (including a test image if the test image is acquired as well as registration candidate images) in the following points of view.

First, one of the points of view is that each of the selected images is an image that is reliably considered as an image of a person to be registered. For example, an image in which there might have been an impersonation by a different person during image capturing and which is not reliably considered as an image of a person in question is excluded from the registration candidate images. To determine whether or not there might have been an impersonation, a useful criterion for the determination may be a criterion as to whether or not a person disappeared from a camera field of view, a criterion as to whether or not two or more persons are included, or the like in a period from start of a registration operation to acquisition of a candidate image in a case of face authentication, for example. The former can be implemented by using a tracking technology of a video, and the latter can be implemented by using a mechanism of face detection. Also in a case of iris authentication, the above can be implemented in a similar method. When a plurality of cameras is used, one or more cameras can be used to confirm that no impersonation is being attempted.

Second, one of the points of view is that a feature to be registered is included in the selected images. A face is required to be included in a case of face authentication, and an iris is required to be included in a case of iris authentication. In general, since a biometric authentication apparatus has a face detection function in a case of face authentication and has an iris detection function in a case of iris authentication, these functions can be used as they stand.

Third, one of the points of view is that the selected images are of high quality. An example of an image of high quality may be a well-focused image, for example. Whether or not an image is well focused can be checked by a known method (such as performing Fourier transformation on an image to check whether or not a high frequency component is present, for example).

Next, the matching score calculation unit 120 sequentially calculates matching scores St to a test image for each of the plurality of registration candidate images acquired by the image acquisition unit 110 (step S102).

The method of calculating the matching score St is not particularly limited. For example, first, a face feature amount that is a parameter representing a feature of a face is extracted from a face image included in the registration candidate image. The face feature amount is a vector amount, which is a combination with a component of a scalar amount expressing a feature of a face image. The component of a feature amount is not particularly limited, and various types thereof can be used. For example, as a component of a feature amount, a positional relationship such as a distance or an angle formed between feature points set at the center or an end of an organ of a face, such as an eye, a nose, a mouth, or the like, the curvature of the outline of a face, a color distribution or a shade value of a face surface, or the like can be used. The number of components of a feature amount is also not particularly limited and can be suitably set in accordance with required matching accuracy, a required processing speed, or the like. Next, a face feature amount extracted from a face image included in the registration candidate image is compared with a face feature amount extracted from a face image included in the test image, and a matching score St representing a similarity of these face feature amounts is calculated. In this example, the matching score St is a numerical value from 0 to 1, which is closer to 1 for a higher similarity of a face feature amount and is closer to 0 for a lower similarity.

As an example herein, it is assumed that there are six registration candidate images of file names “A001”, “A002”, “A003”, “A004”, “A005”, and “A006” and the matching scores St thereof to the test image are values indicated in FIG. 3.

Next, the registration image selection unit 130 initializes a parameter used in image selection (step S103). In this example, 0 is registered for a variable representing the maximum score Sm, and empty data is registered for a variable representing information on candidate data, for example, a character string variable storing a file name of a registration candidate image. Note that step S103 can be performed before an image selection process described later (step S104 to step S106) and, for example, may be performed immediately before or immediately after step S101.

Next, the registration image selection unit 130 sequentially selects a plurality of registration candidate images and repeatedly performs the process from step S104 to step S106.

In step S104, it is determined for the selected registration candidate images whether or not the matching score St calculated in step S102 satisfies a predetermined condition. The predetermined condition herein is that the matching score St is higher than the minimum value (threshold) that meets matching. As a result of the determination in step S104, if the matching score St satisfies the predetermined condition (Yes), the process proceeds to step S105. As a result of the determination in step S104, if the matching score St does not satisfy the predetermined condition (No), the process proceeds to a process for the next registration candidate image (step S104).

For example, if the threshold is 0.50, in the example of FIG. 3, it is determined that the registration candidate image of file name “A004” does not satisfy the predetermined condition, and it is determined that other registration candidate images satisfy the predetermined condition.

It is particularly effective to perform step S104 in excluding a situation where an image unsuitable as a registration image is selected when the population parameter of registration candidate images is small or the like. In general, however, a test image and a registration candidate image are images including the same person, and it is expected that the matching score St is a value larger than or equal to the threshold. Further, a registration candidate image having a matching score St which does not satisfy the threshold is likely to be excluded in a step described later. Therefore, the determination in step S104 is not necessarily required to be performed.

In step S105, it is determined for the selected registration candidate images whether or not the matching score St calculated in step S102 is higher than the maximum score Sm that has been registered so far. As a result of the determination in step S105, if the matching score St is higher than the maximum score Sm (Yes), the process proceeds to step S106. As a result of the determination in step S105, if the matching score St is lower than or equal to the maximum score Sm (No), the process proceeds to a process for the next registration candidate image (step S104).

In step S106, the matching score St of a registration candidate image that is determined to be higher than the maximum score Sm in step S105 is overwritten as the maximum score Sm. Further, information on the registration candidate image is registered as candidate data.

In such a way, the process from step S104 to step S106 is repeatedly performed for each of the plurality of registration candidate images, and thereby the highest matching score St of the matching scores St of the plurality of registration candidate images is finally registered as the maximum score Sm. Further, information on the registration candidate image having the highest matching score St is registered as candidate data. In the example of FIG. 3, the matching score St (=0.94) of the registration candidate image of file name “A005” is the maximum score Sm, and information on this registration candidate image (for example, file name “A005”) is registered as candidate data.

After completion of the process from step S104 to step S106 for all the registration candidate images in the registration image selection unit 130, the process proceeds to step S107.

In step S107, the image registration unit 140 stores the registration candidate image having the highest matching score St in the database of the data storage unit 150 as registration data. The registration data stored in the database of the data storage unit 150 may include the image data acquired in step S101. Further, the registration data stored in the database of the data storage unit 150 may include the feature amount data calculated in step S102. With image data being stored in advance, a user may easily identify a person registered in the database. Further, with feature amount data being stored in advance, the process of feature amount conversion which would otherwise be performed in a matching process with the registration data can be omitted, and this enables a faster matching process.

Note that, although one registration candidate image whose matching score to the test image is the highest is selected as the registration data in this example, a plurality of registration candidate images whose matching scores are ranked high may be selected as the registration data.

As described above, in the present example embodiment, determination as to whether or not a registration candidate image is good is automatically performed based on a matching score to a test image. Therefore, determination to select a suitable registration image out of a plurality of registration candidate images can be performed in a faster and more accurate manner than in a case where a person visually determines whether or not a registration candidate image is good. Accordingly, a database suitable for biometric authentication can be constructed.

The information processing method of the present example embodiment may be preferably applied to a case where a matching score of a registration candidate image to a test image is assumed to be sufficiently higher than a matching score of a registration image to an image of another person, for example. The case of being assumed to be higher than a matching score of a registration image to an image of another person may be, for example, a case where a camera that acquires an image has high performance, an acquired test image and a registration candidate image are of high quality, and a sufficiently high value is expected for a matching score between images of the same person or the like.

Next, an example of a hardware configuration of the information processing apparatus 100 according to the present example embodiment will be described with reference to FIG. 4.

The information processing apparatus 100 according to the present example embodiment can be implemented by a hardware configuration similar to general information processing apparatuses. That is, as illustrated in FIG. 4, for example, the information processing apparatus 100 may include a processor 200, a main storage unit 202, a communication unit 204, and an input/output interface unit 206.

The processor 200 is a control and calculation device responsible for control of each function block of the information processing apparatus 100 or a calculation process. One of a central processing unit (CPU), a graphics processing unit (GPU), a field-programmable gate array (FPGA), a digital signal processor (DSP), and an application specific integrated circuit (ASIC) may be used for the processor 200, or a plurality of the above may be used in parallel for the processor 200.

The main storage unit 202 is a storage unit used as a data working area or a temporary data storage area and is formed of a memory such as a random access memory (RAM). The communication unit 204 is an interface used for transmitting or receiving data via a network. The input/output interface unit 206 is an interface connected to an output device 210, an input device 212, a storage device 214, or the like, which are externally located, and used for transmitting or receiving data. The processor 200, the main storage unit 202, the communication unit 204, and the input/output interface unit 206 are connected to each other via a system bus 208.

The main storage unit 202 can be used as a working area used for performing calculation when the matching score St is calculated or the registration data is extracted. The processor 200 functions as a control unit to control these calculation processes and serves as the image acquisition unit 110, the matching score calculation unit 120, the registration image selection unit 130, and the image registration unit 140 together with the main storage unit 202 or the input/output interface unit 206. The storage device 214 can be used as the data storage unit 150 that stores registration data selected by the registration image selection unit 130.

The communication unit 204 is a communication interface based on a specification such as Ethernet (registered trademark), Wi-Fi (registered trademark), or the like, which is a module used for communicating with another device. Registration data stored in the storage device 214 (the data storage unit 150) may be received from another device via the communication unit 204. For example, registration data constructed in a device different from the information processing apparatus of the present example embodiment, such as an authentication device, for example, can be received via the communication unit 204 and stored in the storage device 214. The registration data stored in such a way can be used in a matching process and can be utilized when candidate data is extracted in an information processing method according to a second example embodiment described later.

The input device 212 is a keyboard, a mouse, a touch panel, or the like and is used by the user for inputting predetermined information to the information processing apparatus 100. Further, the input device 212 can also be used as a component for inputting a registration candidate image or a test image. For example, when the registration candidate image or the test image is a two-dimensional image, an image reading device can be applied as the input device 212. The output device 210 may be a display device, a printer device, or the like and is used for notifying the user of a calculation on-going status or a calculation result. The storage device 214 can be formed of, for example, a hard disk device or the like formed of a nonvolatile memory such as a read only memory (ROM), a magnetic disk, a semiconductor memory, or the like.

The function of each unit of the information processing apparatus 100 according to the present example embodiment can be realized in a hardware-like manner by implementing circuit components that are hardware components such as a large scale integration (LSI) in which a program is embedded. Alternatively, the above function can be realized in a software-like manner by storing a program that provides the function in the storage device 214, loading the program into the main storage unit 202, and executing the program by the processor 200.

When a person determines whether or not the image quality is good, an unfamiliar person may be unable to make correct determination, evaluation of image quality may vary depending on a determining person, or a long time may be taken for the determination. Although it may be considered to use an image analysis technology such as Fourier transformation to numerically evaluate whether or not an image is focused, for example, it is difficult to indicate what value the numerical value should be above. Further, focus is not the only factor that determines whether or not a registration image is good. That is, only by externally observing the behavior of an algorithm used in authentication determination of an image, it is difficult in general to know all the features of an image suitable as a registration image and the degree these features should be satisfied. Further, even if the features of an image suitable as a registration image and the degree these features should be satisfied are determined in a certain algorithm, a change of the algorithm may change the features of an image suitable as a registration image and the degree these features should be satisfied, and it is thus not practical to prepare a determination scheme on an algorithm basis.

According to the present example embodiment, determination to select a suitable registration image out of a plurality of registration candidate images can be performed in a faster and more accurate manner than in a case where a person visually determines whether or not a registered candidate image is good. Accordingly, a database suitable for biometric authentication can be constructed.

### Second Example Embodiment

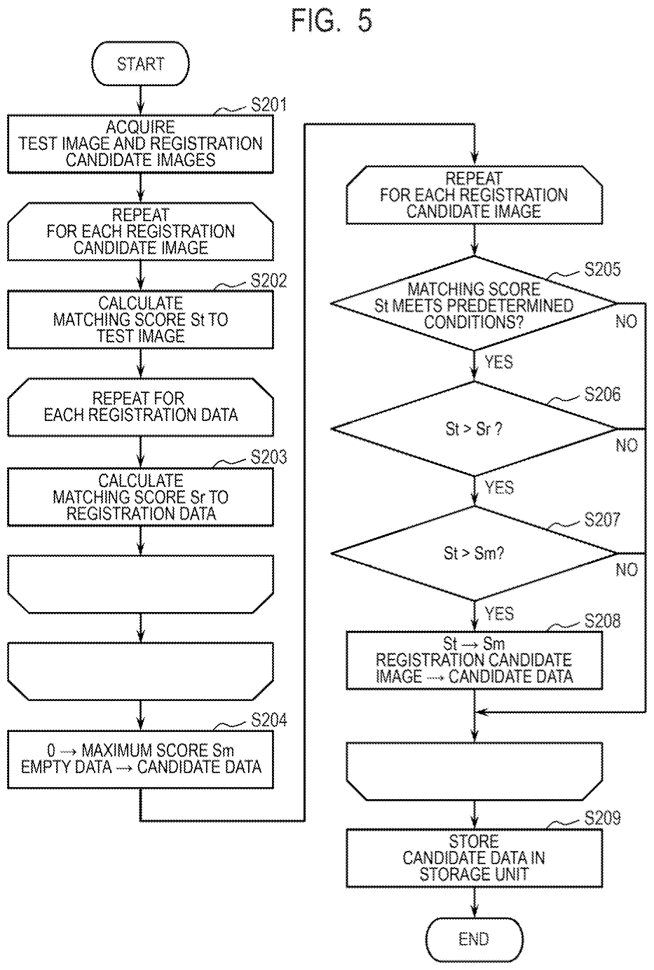

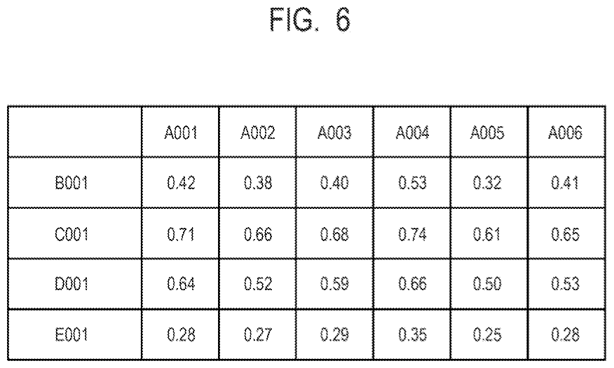

An information processing method according to a second example embodiment will be described with reference to FIG. 5 and FIG. 6. The same components as those of the first example embodiment will be labeled with the same references, and the description thereof will be omitted or simplified. FIG. 5 is a flowchart illustrating the information processing method according to the present example embodiment. FIG. 6 is a diagram illustrating an example of application of the information processing method according to the present example embodiment.

In the present example embodiment, a method will be described in which, when registration data on another person have already been stored in the data storage unit 150, such registration data is also used to select a registration image of a person to be additionally registered. Note that a basic configuration of the information processing apparatus 100 for performing the information processing method of the present example embodiment is the same as that in the first example embodiment.

First, the image acquisition unit 110 acquires, from an external device, a plurality of image data including face images of a person to be registered. In the present example embodiment, one of the plurality of image data acquired in such a way is used as a test image, and a plurality of remaining images are used as registration candidate images (step S201). The registration candidate image and the test image are the same as those in the first example embodiment.

Next, the matching score calculation unit 120 sequentially selects a plurality of registration candidate images and repeatedly performs the process of step S202 and step S203. Specifically, in step S202, the matching score St to the test image is calculated for the selected registration candidate images. Further, in step S203, for the selected registration candidate images, each matching score Sr to each of the registration data on other persons registered in the database of the data storage unit 150 is calculated. The method of calculating the matching score Sr is the same as the method of calculating the matching score St.

As an example herein, it is assumed that there are six registration candidate images of file names “A001”, “A002”, “A003”, “A004”, “A005”, and “A006” and the matching scores St thereof to the test image are values indicated in FIG. 3. Further, in the database of the data storage unit 150, it is assumed that there are registration data of file names “B001”, “C001”, “D001”, and “E001” for four persons as registration data on other persons and the matching scores Sr thereof to these registration data are values indicated in FIG. 6.

Note that, when no registration data for another person is registered in the database of the data storage unit 150 or when the population parameter of registration data for other persons is small, data for another person acquired in a different environment may be used instead of the registration data. Such data is not particularly limited and may be data disclosed on a public database, data acquired in a different place, or the like. An increase in the number of registration data on other persons to be matched with a registration candidate image makes it possible to extract an image of higher matching accuracy out of registration candidate images.

Next, the registration image selection unit 130 initializes a parameter used in image selection (step S204). In this step, 0 is registered for a variable representing the maximum score Sm, and empty data is registered for a variable representing information on candidate data, for example, a character string variable storing a file name of a registration candidate image. Note that step S204 can be performed before an image selection process described later (step S205 to step S208) and, for example, may be performed immediately before or immediately after step S201.

Next, the registration image selection unit 130 sequentially selects a plurality of registration candidate images and repeatedly performs the process from step S205 to step S208.

In step S205, it is determined for the selected registration candidate images whether or not the matching score St calculated in step S202 satisfies a predetermined condition. The determination in step S202 is performed in the same manner as the determination in step S104 in the first example embodiment. As a result of the determination in step S205, if the matching score St satisfies the predetermined condition (Yes), the process proceeds to step S206. As a result of the determination in step S205, if the matching score St does not satisfy the predetermined condition (No), the process proceeds to a process (step S205) for the next registration candidate image.

For example, if the threshold is 0.50, in the example of FIG. 3, it is determined that the registration candidate image of file name “A004” does not satisfy the predetermined condition, and it is determined that the remaining registration candidate images satisfy the predetermined condition.

In step S206, it is determined for the selected registration candidate images whether or not the matching score St calculated in step S202 is higher than the matching score Sr calculated in step S203. As a result of the determination in step S206, if the matching score St is higher than all the matching scores Sr calculated in step S203 (Yes), the process proceeds to step S207. As a result of the determination in step S206, if the matching score St is lower than or equal to at least one matching score Sr (No), the process proceeds to a process (step S205) for the next registration candidate image.

For example, in the example of FIG. 3 and FIG. 6, it is determined that the registration candidate images of file names “A001”, “A002”, “A003”, “A005”, and “A006” satisfy the predetermined condition. When the process of step S205 is omitted, it is determined that the registration candidate image of file name “A004” does not satisfy the condition of step S206.

In step S207, it is determined for the selected registration candidate images whether or not the matching score St calculated in step S202 is higher than the maximum score Sm that has been registered so far. As a result of the determination in step S207, if the matching score St is higher than the maximum score Sm (Yes), the process proceeds to step S208. As a result of the determination in step S207, if the matching score St is lower than or equal to the maximum score Sm (No), the process proceeds to a process (step S205) for the next registration candidate image.

In step S208, the matching score St of a registration candidate image that is determined to be higher than the maximum score Sm in step S207 is overwritten as the maximum score Sm. Further, information on the registration candidate image is registered as candidate data.

In such a way, the process from step S205 to step S208 is repeatedly performed for each of the plurality of registration candidate images, and thereby the highest matching score St of the matching scores St of the plurality of registration candidate images is finally registered as the maximum score Sm. Further, information on a registration candidate image having the highest matching score St is registered as candidate data. In the example of FIG. 3 and FIG. 6, the matching score St of the registration candidate image of file name “A005” is the maximum score Sm, and information on this registration candidate image is registered as candidate data. The image data selected in such a way is the image data having the highest matching score St of the registration candidate images and has a higher matching score St than all the registration data registered in the database of the data storage unit 150.

After completion of the process from step S205 to step S208 for all the registration candidate images in the registration image selection unit 130, the process proceeds to step S209.

In step S209, the image registration unit 140 stores the registration candidate image having the highest matching score St in a database of the data storage unit 150 as registration data.

Note that, although one registration candidate image whose matching score to the test image and to a registration image of another person is the highest is selected as the registration data in this example, a plurality of registration candidate images whose matching scores are ranked high may be selected as the registration data.

If the candidate data remains to be empty data in step S209, a person included in a registration candidate image might have already been registered in the database of the data storage unit 150. In such a case, a notification such as “already registered” may be displayed on a screen of a display device.

As described above, in the present example embodiment, determination as to whether or not a registration candidate image is good is automatically performed based on a matching score to a test image. Therefore, determination to select a suitable registration image out of a plurality of registration candidate images can be performed in a faster and more accurate manner than in a case where a person visually determines whether or not a registration candidate image is good. Further, in addition to the matching score St to the test image, since the matching score Sr to the registration data on another person is also used as determination criteria, an image that is identifiable to the registration data on another person can be efficiently extracted out of registration candidate images. Accordingly, a database suitable for biometric authentication can be constructed.

Note that registration data on another person read from the database of the data storage unit 150 may be registration data used in an actual matching process or authentication process.

As described above, according to the present example embodiment, determination to select a suitable registration image out of a plurality of registration candidate images can be performed in a faster and more accurate manner than in a case where a person visually determines whether or not a registration candidate image is good. Further, since the matching score to the registration data on another person is also used as determination criteria in addition to the matching score to the test image, an image that is identifiable to the registration data on another person can be efficiently extracted out of registration candidate images. Accordingly, a database suitable for biometric authentication can be constructed.

### Third Example Embodiment

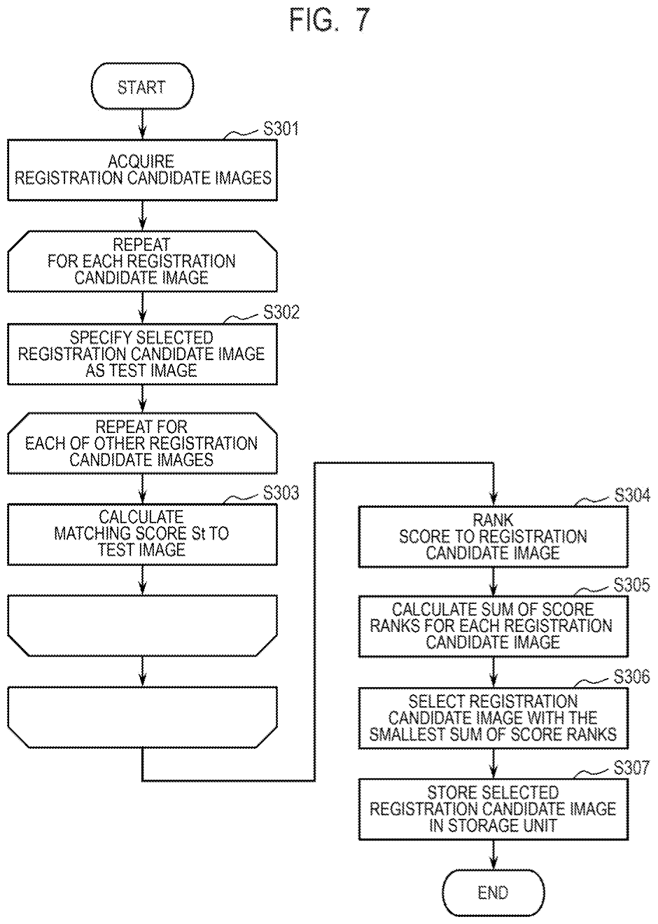

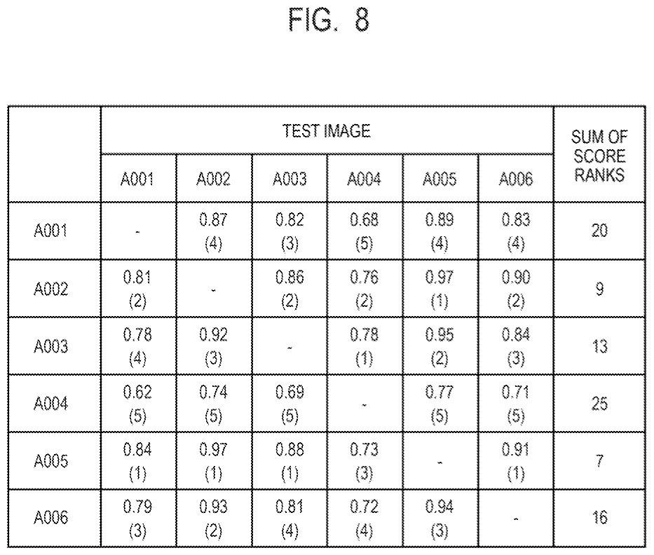

An information processing method according to a third example embodiment will be described with reference to FIG. 7 and FIG. 8. The same components as those of the first and second example embodiments will be labeled with the same references, and the description thereof will be omitted or simplified. FIG. 7 is a flowchart illustrating the information processing method according to the present example embodiment. FIG. 8 is a diagram illustrating an example of application of the information processing method according to the present example embodiment.

In the first and second example embodiments, the example in which the matching score St to one test image is calculated for each of a plurality of registration candidate images, and a registration candidate image having the highest matching score St is determined as a registration image has been illustrated. However, it is considered that, when a different image is selected as the test image, the image extracted as a registration image may also be a different image. In particular, if an image selected as a test image is unsuitable, such as being not clear, as a reference for calculation of a matching score, it is also assumed that a suitable image as registration data is not extracted out of the registration candidate images.

In the present example embodiment, an information processing method that can extract the optimum registration image regardless of selection of a test image will be described. Note that the basic configuration of the information processing apparatus 100 for implementing the information processing method of the present example embodiment is the same as that in the first example embodiment.

First, the image acquisition unit 110 acquires, from an external device, a plurality of image data including face images of a person to be registered. In the present example embodiment, the plurality of image data acquired in such a way are used as registration candidate images (step S301). Note that each of the plurality of acquired image data is a registration candidate image and is also used as a test image. The registration candidate images are also used as the test image, and thereby the number of images to be acquired can be reduced. Unless the number of images to be acquired is specifically limited, a plurality of test images may be prepared separately from registration candidate images.

Next, the matching score calculation unit 120 sequentially selects a plurality of registration candidate images and repeatedly performs the process of step S302 and step S303. Specifically, in step S302, a selected registration candidate image is specified as a test image. Next, in step S303, the matching score St to the specified test image is calculated for each of the remaining registration candidate images.

Next, in step S304, for each of the registration candidate images specified as the test image, the matching scores St each calculated for each of the remaining registration candidate images are sorted and ranked in descending order of the value thereof.

FIG. 8 represents an example of the matching scores St calculated in accordance with the procedure of step S302 and step S303 for six registration candidate images of file names “A001”, “A002”, “A003”, “A004”, “A005”, and “A006”. The numerical value in a bracket denotes a rank (score rank) when the matching scores St calculated with respect to the same test image are sorted in descending order. For example, when the registration candidate image of file name “A002” is selected as a test image, the matching score of the registration candidate image of file name “A001” is 0.87, and the score rank thereof is 4. Further, the matching score of the registration candidate image of file name “A003” is 0.92, and the score rank thereof is 3. Further, the matching score of the registration candidate image of file name “A004” is 0.74, and the score rank thereof is 5. Further, the matching score of the registration candidate image of file name “A005” is 0.97, and the score rank thereof is 1. Further, the matching score of the registration candidate image of file name “A006” is 0.93, and the score rank thereof is 2.

Next, the registration image selection unit 130 calculates, on a registration candidate image basis, the sum of score ranks acquired when other registration candidate images are used as the test image (step S305) In the case of the example of FIG. 8, the sum of score ranks for the registration candidate image of file name “A001” is 20, and the sum of score ranks for the registration candidate image of file name “A002” is 9. The sum of score ranks for the registration candidate image of file name “A003” is 13, and the sum of score ranks for the registration candidate image of file name “A004” is 25. The sum of score ranks for the registration candidate image of file name “A005” is 7, and the sum of score ranks for the registration candidate image of file name “A006” is 16.

Next, the registration image selection unit 130 selects a registration candidate image having the smallest sum of score ranks calculated in step S305 as registration data out of the plurality of registration candidate images (step S306). In the case of the example of FIG. 8, the registration candidate image of file name “A005” is selected as registration data.

The value of a score rank is smaller when the similarity to a test image is higher. Therefore, selecting a registration candidate image having the smallest sum of score ranks denotes selecting a registration candidate image having the highest similarity to other registration candidate images. Accordingly, a more suitable registration image can be extracted than in a case where a registration image is extracted by using a single test image as a reference.

Next, the image registration unit 140 stores the registration candidate image selected in step S305 in the data storage unit 150 as registration data (step S307).

As described above, in the present example embodiment, determination as to whether or not a registration candidate image is good is automatically performed based on a matching score to a test image. Therefore, determination to select a suitable registration image out of a plurality of registration candidate images can be performed in a faster and more accurate manner than in a case where a person visually determines whether or not a registration candidate image is good. Further, a plurality of test images is used to calculate a matching score to each of the registration candidate images. Therefore, the optimum registration image can be extracted compared to a case where a single image is used as the test image.

Note that, although all the registration candidate images are used as the test image in the present example embodiment, a predetermined number, which is two or greater, of registration candidate images of a plurality of registration candidate images may be used as the test image. When the number of calculated matching scores differs for respective registration candidate images, the average value of score ranks may be used instead of the sum of score ranks.

Further, although neither the determination of step S104 in the first example embodiment nor the determination of step S205 and S206 in the second example embodiment is performed in the present example embodiment, these determination steps may be further performed.

As described above, according to the present example embodiment, determination to select a suitable registration image out of a plurality of registration candidate images can be performed in a faster and more accurate manner than in a case where a person visually determines whether or not a registration candidate image is good. Further, a plurality of test images is used to calculate a matching score to each of the registration candidate images. Therefore, the optimum registration image can be extracted compared to a case where a single image is used as the test image.

Accordingly, a database suitable for biometric authentication can be constructed. Further, since test images are specified from a plurality of registration candidate images, the number of images to be acquired can be reduced.

### Fourth Example Embodiment

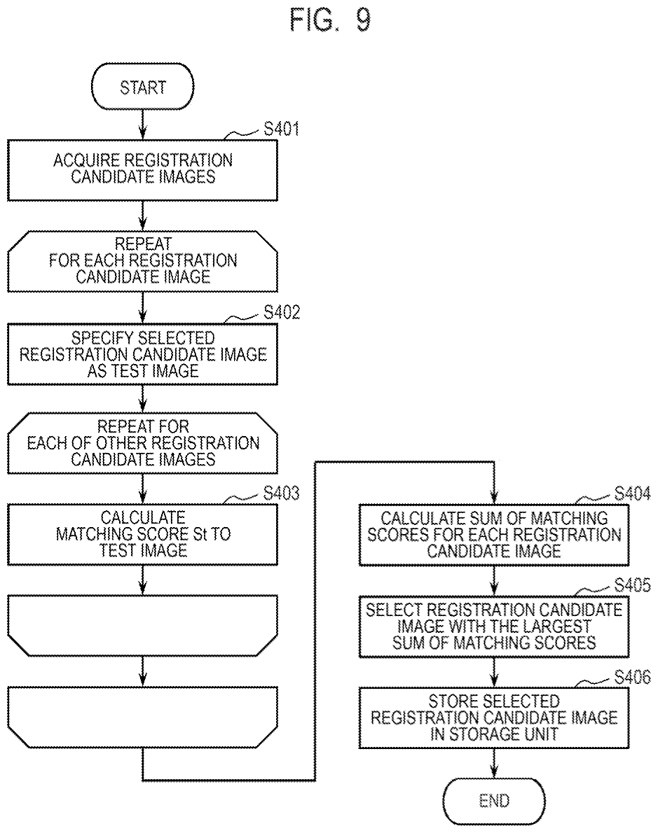

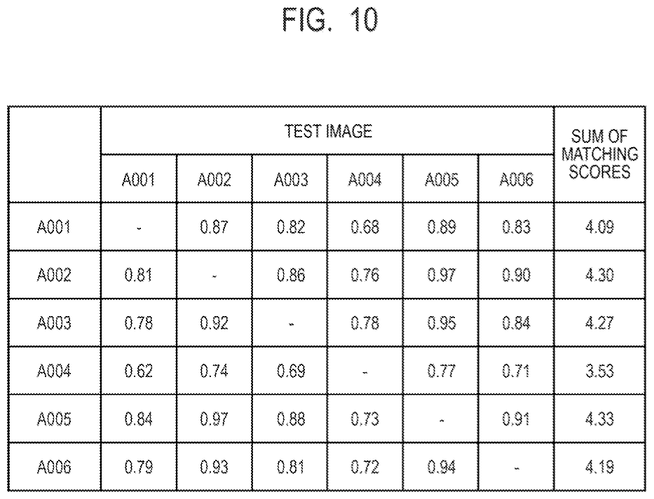

An information processing method according to a fourth example embodiment will be described with reference to FIG. 9 and FIG. 10. The same components as those of the first to third example embodiments will be labeled with the same references, and the description thereof will be omitted or simplified. FIG. 9 is a flowchart illustrating the information processing method according to the present example embodiment. FIG. 10 is a diagram illustrating an example of application of the information processing method according to the present example embodiment.

In the present example embodiment, as with the third example embodiment, an information processing method that can extract the optimum registration image regardless of selection of a test image will be described. Note that the basic configuration of the information processing apparatus 100 for implementing the information processing method of the present example embodiment is the same as that in the first example embodiment.

First, the image acquisition unit 110 acquires, from an external image acquisition device or the like, a plurality of face images of a person to be registered. The plurality of face images acquired in such a way are used as registration candidate images (step S401). Note that each of the plurality of acquired image data is a registration candidate image and is also used as a test image. The registration candidate images are also used as the test image, and thereby the number of images to be acquired can be reduced. Unless the number of images to be acquired is specifically limited, a plurality of test images may be prepared separately from registration candidate images.

Next, the matching score calculation unit 120 sequentially selects a plurality of registration candidate images and repeatedly performs the process of step S402 and step S403. Specifically, in step S402, a selected registration candidate image is specified as a test image. Next, in step S403, the matching score St to the specified test image is calculated for each of the remaining registration candidate images.

FIG. 10 represents an example of a list of the matching scores St calculated in accordance with the procedure of step S302 and step S303 for six registration candidate images of file names “A001”, “A002”, “A003”, “A004”, “A005”, and “A006”. For example, when the registration candidate image of file name “A002” is selected as a test image, the matching score St of the registration candidate image of file name “A001” is 0.87. The matching score St of the registration candidate image of file name “A003” is 0.92. The matching score St of the registration candidate image of file name “A004” is 0.74. The matching score St of the registration candidate image of file name “A005” is 0.97. The matching score St of the registration candidate image of file name “A006” is 0.93.

Next, the registration image selection unit 130 calculates, on a registration candidate image basis, the sum of matching scores St acquired when other registration candidate images are used as the test image (step S404). In the case of the example of FIG. 10, the sum of matching scores St for the registration candidate image of file name “A001” is 4.09, and the sum of matching scores St for the registration candidate image of file name “A002” is 4.30. Further, the sum of matching scores St for the registration candidate image of file name “A003” is 4.27, and the sum of matching scores St for the registration candidate image of file name “A004” is 3.53. Further, the sum of matching scores St for the registration candidate image of file name “A005” is 4.33, and the sum of matching scores St for the registration candidate image of file name “A006” is 4.19.

Next, the registration image selection unit 130 selects a registration candidate image having the largest sum of matching scores St calculated in step S404 as registration data out of the plurality of registration candidate images (step S405). In the case of the example of FIG. 10, the registration candidate image of file name “A005” is selected as registration data.

The value of a matching score St is larger when the similarity to a test image is higher. Therefore, selecting a registration candidate image having the largest sum of matching scores St denotes selecting a registration candidate image having the highest similarity to other registration candidate images. Accordingly, a more suitable registration image can be extracted than in a case where a registration image is extracted by using a single test image as a reference.

Next, the image registration unit 140 stores the registration candidate image selected in step S404 in the data storage unit 150 as registration data (step S405).

As described above, in the present example embodiment, determination as to whether or not a registration candidate image is good is automatically performed based on a matching score to a test image. Therefore, determination to select a suitable registration image out of a plurality of registration candidate images can be performed in a faster and more accurate manner than in a case where a person visually determines whether or not a registration candidate image is good. Further, a plurality of test images is used to calculate a matching score to each of the registration candidate images. Therefore, the optimum registration image can be extracted compared to a case where a single image is used as the test image.

Note that, although all the registration candidate images are used as the test image in the present example embodiment, a predetermined number, which is two or greater, of registration candidate images of a plurality of registration candidate images may be used as the test image. When the number of calculated matching scores differs for respective registration candidate images, the average value of matching scores may be used instead of the sum of matching scores.

Further, although neither the determination of step S104 in the first example embodiment nor the determination of step S205 and S206 in the second example embodiment is performed in the present example embodiment, these determination steps may be further performed.

As described above, according to the present example embodiment, determination to select a suitable registration image out of a plurality of registration candidate images can be performed in a faster and more accurate manner than in a case where a person visually determines whether or not a registration candidate image is good. Further, a plurality of test images is used to calculate a matching score to each of the registration candidate images. Therefore, the optimum registration image can be extracted compared to a case where a single image is used as the test image. Accordingly, a database suitable for biometric authentication can be constructed. Further, since test images are specified from a plurality of registration candidate images, the number of images to be acquired can be reduced.

### Fifth Example Embodiment

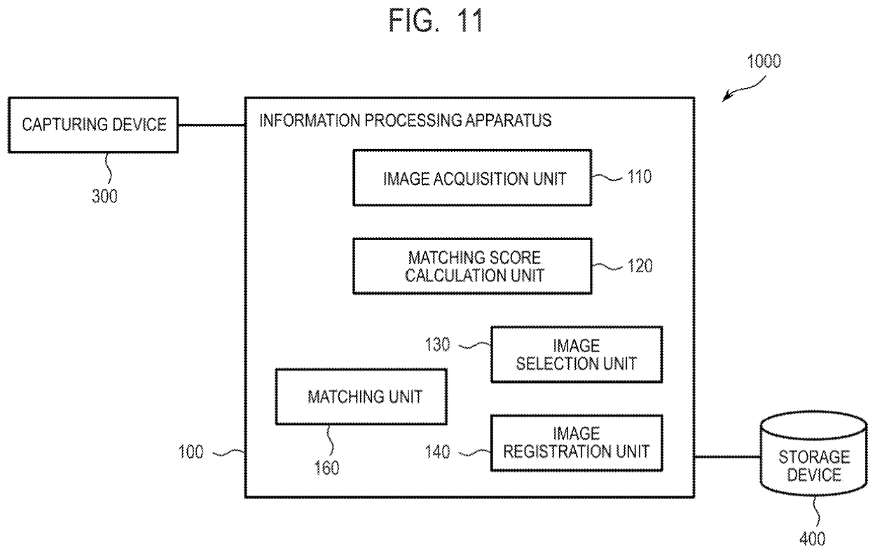

A matching system according to a fifth example embodiment will be described with reference to FIG. 11. The same components as those of the first to fourth example embodiments will be labeled with the same references, and the description thereof will be omitted or simplified. FIG. 11 is a block diagram illustrating an example of the configuration of the matching system according to the present example embodiment.

In the present example embodiment, a matching system to which the information processing apparatus described in any of the first to fourth example embodiments is applied will be described.

As illustrated in FIG. 11, a matching system 1000 according to the present example embodiment is formed of the information processing apparatus 100, a capturing device 300, and a storage device 400. The capturing device 300 is connected to the information processing apparatus 100. The capturing device 300 may be a part of the information processing apparatus 100 or may be connected to the information processing apparatus 100 via a network or the like. The storage device 400 is connected to the information processing apparatus 100. The storage device 400 may be a part of the information processing apparatus 100 (for example, the data storage unit 150 in the first example embodiment) or may be connected to the information processing apparatus 100 via a network or the like.

The information processing apparatus 100 further has a matching unit 160 in addition to the image acquisition unit 110, the matching score calculation unit 120, the registration image selection unit 130, and the image registration unit 140 described in the first example embodiment. The matching unit 160 is a function block having a function of matching image data on a person captured by the capturing device 300 with image data on a person registered in the storage device 400 and determining whether or not the person captured by the capturing device 300 is the person registered in the storage device 400. A determination result from the matching unit 160 can be externally notified via the output device 210. Further, a determination result from the matching unit 160 can be utilized for authentication in a gate apparatus or the like.

The matching system 1000 has a function of selecting and registering image data on a person captured by the capturing device 300 and a function of determining whether or not a person captured by the capturing device 300 is a registered person.

Since the function of selecting and registering image data on a person captured by the capturing device 300 is the same as that described in the first to fourth example embodiments, the description thereof is omitted here.

The function of determining whether or not a person captured by the capturing device 300 is a registered person can be implemented by the image acquisition unit 110, the matching score calculation unit 120, and the matching unit 160 of the components of the information processing apparatus 100.

First, the capturing device 300 captures an image of a person entering the field of view of the capturing device 300 and outputs image data to the information processing apparatus 100. The image acquisition unit 110 of the information processing apparatus 100 acquires image data output from the capturing device 300 and outputs the acquired image data to the matching score calculation unit 120.

Next, the matching score calculation unit 120 calculates, for image data acquired from the image acquisition unit 110, the matching score Sc to image data on a person registered in a database of the storage device 400.

To calculate the matching score Sc, the matching score calculation unit 120 used for calculating the matching score St of a registration candidate image to a test image can be used. In other words, when calculating the matching score St of a registration candidate image to a test image, it is preferable to use the same algorithm as the algorithm used when calculating the matching score Sc. With such a configuration, the algorithm used when calculating the matching score Sc can select image data that can best distinguish an image of a person of question from an image of another person out of registration candidate images, and this can improve matching accuracy.

Next, the matching unit 160 extracts image data having the highest matching score Sc calculated by the matching score calculation unit 120 out of image data on the registered person. Then, If the matching score Sc of the extracted image data is higher than a predetermined threshold, it is then determined that the person captured by the capturing device 300 is the same person as one of the persons registered in the database. On the other hand, if the matching score Sc of the extracted image data is lower than or equal to the predetermined threshold, it is determined that the person captured by the capturing device 300 is a person not registered in the database.

As described above, in the present example embodiment, the matching score calculation unit 120 or registration data used in an actual matching process are used as they stand, and an image having the highest matching score out of registration candidate images is selected as registration data. Therefore, in constructing a matching system having a function of selecting a registration image, it is not required to separately prepare such a component that estimates an image whose matching score is expected to be the highest out of registration candidate images, and it is thus possible to simplify the system and select a registration image suitable for the present authentication system.

The matching system according to the present example embodiment may be applied for various purposes. While not particularly limited, the matching system according to the present example embodiment can be used to identify a purchaser in payment at a store, for example.

As described above, according to the present example embodiment, in constructing a matching system having a function of selecting a registration image, it is not required to separately prepare such a component that estimates an image whose matching score is expected to be the highest out of registration candidate images, and it is thus possible to simplify the system and select a registration image suitable for the present authentication system.

### Sixth Example Embodiment

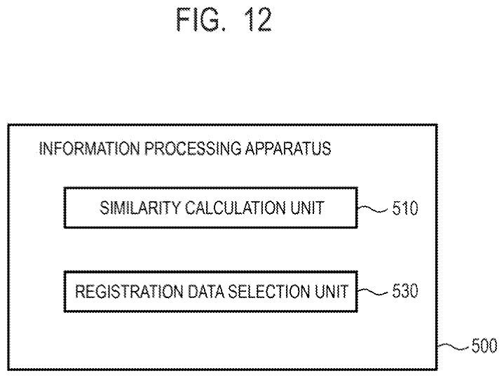

An information processing apparatus according to a sixth example embodiment will be described with reference to FIG. 12. The same components as those of the first to fifth example embodiments will be labeled with the same references, and the description thereof will be omitted or simplified. FIG. 12 is a block diagram illustrating a general configuration of the information processing apparatus according to the present example embodiment.

As illustrated in FIG. 12, the information processing apparatus 500 according to the present example embodiment has at least a similarity calculation unit 510 and a registration data selection unit 530.

The similarity calculation unit 510 has a function of calculating, for each of a plurality of registration candidate data each including biometric information on a single person, the similarity to test data including biometric information on the person of interest. The matching score calculation unit 120 described in the first to fifth example embodiments is an example of the similarity calculation unit 510.

The registration data selection unit 530 has a function of selecting registration candidate data whose similarity to test data is ranked high out of a plurality of registration candidate data as registration data to be registered in a data storage unit for matching the person of interest. The registration image selection unit 130 described in the first to fifth example embodiments is an example of the registration data selection unit 530.

As described above, according to the present example embodiment, determination to select a suitable registration data out of a plurality of registration candidate data can be performed in a faster and more accurate manner than in a case where a person visually determines whether or not a registration candidate image is good. Accordingly, a database suitable for biometric authentication can be constructed.

### Seventh Example Embodiment

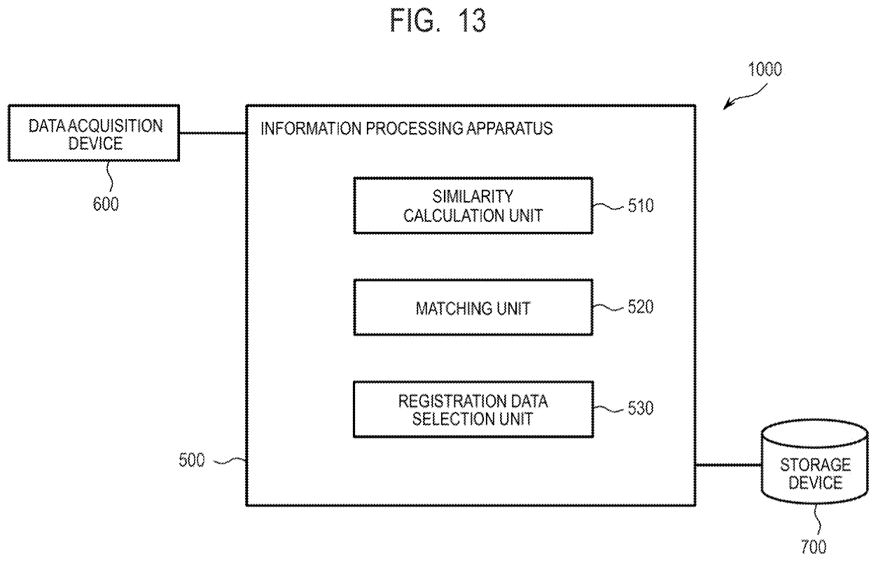

An information processing apparatus according to a seventh example embodiment will be described with reference to FIG. 13. The same components as those of the first to sixth example embodiments will be labeled with the same references, and the description thereof will be omitted or simplified. FIG. 13 is a block diagram illustrating a general configuration of the matching system according to the present example embodiment.

As illustrated in FIG. 13, the matching system 1000 according to the present example embodiment has at least the information processing apparatus 500, a data acquisition device 600, and a storage device 700. The information processing apparatus 500 has at least the similarity calculation unit 510, a matching unit 520, and the registration data selection unit 530.

The data acquisition device 600 has a function of acquiring biometric information data on a person. The capturing device 300 described in the fifth example embodiment is an example of the data acquisition device 600.

The storage device 700 has a function of registering a plurality of biometric information data on a plurality of persons. The data storage unit 150 described in the first to fourth example embodiments and the storage device 400 described in the fifth example embodiment each are an example of the storage device 700.

The information processing apparatus 500 has the similarity calculation unit 510 that calculates a similarity between biometric information data acquired by the data acquisition device 600 and a plurality of biometric information data registered in the storage device 700 and the matching unit 520 that, based on the similarity, determines whether or not a person indicated by the biometric information data acquired by the data acquisition device 600 is a person registered in the storage device 700. The matching score calculation unit 120 described in the first to fifth example embodiments is an example of the similarity calculation unit 510. The matching unit 160 described in the fifth example embodiment is an example of the matching unit 520.

The similarity calculation unit 510 is further configured to calculate, for each of a plurality of registration candidate data each including biometric information on a single person, the similarity to test data including biometric information on the person of interest.

Further, the information processing apparatus 500 further has the registration data selection unit 530 that selects registration data to be registered in the storage device 700 for matching the person of interest out of a plurality of registration candidate data based on the similarity of each of the plurality of registration candidate data to test data and the similarity to each of the plurality of biometric information data on a plurality of persons. The registration image selection unit 130 described in the first to fifth example embodiments is an example of the registration data selection unit 530.

As described above, according to the present example embodiment, in constructing a matching system having a function of selecting registration data, it is not required to separately prepare such a component that estimates data whose similarity is expected to be ranked high out of registration candidate data, and it is thus possible to simplify the system and select a registration image suitable for the present authentication system.

### Modified Example Embodiment

The present disclosure is not limited to the example embodiments described above, and various modifications are possible.

For example, an example in which a configuration of a part of any of the example embodiments is added to another example embodiment or replaced with a configuration of a part of another example embodiment is an example embodiment of the present disclosure.

Further, although image data has been illustrated as an example of biometric information data on a person to be matched in the example embodiments described above, biometric information data is not limited to image data. For example, the biometric information data may be voiceprint data recording a voice of a person, data representing a behavioral feature such as a manner of walking, or the like in addition to image data. Further, although the example of a face image as image data has been illustrated in the example embodiments described above, the image data is not limited to a face image. For example, the image data may be an iris image, a fingerprint image, a palmprint image, a vein image, an image representing an auricle shape, or the like.

Further, although the matching scores St and Sr are each defined as a numerical value from 0 to 1 in the example embodiments described above, the definitions of the matching scores St and Sr are not limited thereto. Further, although the matching score St or Sr is used as an index representing a similarity in the example embodiments described above, the matching score St or Sr may be used as an index representing a dissimilarity. In such a case, a higher dissimilarity results in higher values of matching scores St and Sr.

Further, although six images are used as the registration candidate images in the example embodiments described above, the number of registration candidate images is not particularly limited.

Further, the scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the individual program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

Note that all the above example embodiments are mere illustration of embodied examples in implementing the present disclosure, and the technical scope of the present disclosure is not to be construed in a limiting sense by these example embodiments. That is, the present disclosure can be implemented in various forms without departing from the technical concept or the primary feature thereof.

The whole or part of the example embodiments disclosed above can be described as, but not limited to, the following supplementary notes.

### (Supplementary Note 1)

An information processing apparatus comprising:
a similarity calculation unit that, for each of a plurality of registration candidate data each including biometric information on a single person, calculates a similarity to test data including the biometric information on the person; and
a registration data selection unit that selects, as registration data to be registered in a data storage unit for matching the person, registration candidate data whose similarity to the test data is ranked high out of the plurality of registration candidate data.

### (Supplementary Note 2)

The information processing apparatus according to supplementary note 1,
wherein the data storage unit has a plurality of data including biometric information on a plurality of persons that are different from the person, and
wherein the registration data selection unit selects the registration data based on the similarity to the test data and a similarity of each of the plurality of registration candidate data to each of the plurality of data.

### (Supplementary Note 3)

The information processing apparatus according to supplementary note 2, wherein the registration data selection unit selects, as the registration data, registration candidate data whose similarity to the test data is ranked high and which has a similarity higher than the similarity to the plurality of data out of the plurality of registration candidate data.

### (Supplementary Note 4)

The information processing apparatus according to any one of supplementary notes 1 to 3, wherein the registration data is registration candidate data whose similarity to the test data is the highest out of the plurality of registration candidate data.

### (Supplementary Note 5)

The information processing apparatus according to any one of supplementary notes 1 to 4, wherein the similarity calculation unit calculates the similarity by using registration candidate data other than registration candidate data of interest as the test data for each of the plurality of registration candidate data.

### (Supplementary Note 6]

The information processing apparatus according to any one of supplementary notes 1 to 4, wherein the similarity calculation unit calculates the similarity by using each of all of registration candidate data other than registration candidate data of interest as the test data for each of the plurality of registration candidate data.

### (Supplementary Note 7)

The information processing apparatus according to supplementary note 6, wherein the registration data selection unit selects, as the registration data, registration candidate data whose similarity to registration candidate data other than registration candidate data of interest is the highest out of the plurality of registration candidate data.

### (Supplementary Note 8)

The information processing apparatus according to supplementary note 7,
wherein the similarity corresponds to a matching score to the test data, and
wherein the registration candidate data whose similarity to the registration candidate data other than registration candidate data of interest is the highest is registration candidate data having the smallest sum of score ranks of the matching score to the registration candidate data other than the registration candidate data of interest.

### (Supplementary Note 9)

The information processing apparatus according to supplementary note 7,
wherein the similarity corresponds to a matching score to the test data, and
wherein the registration candidate data whose similarity to the registration candidate data other than the registration candidate data of interest is the highest is registration candidate data having the largest sum of matching scores to the registration candidate data other than the registration candidate data of interest.

### (Supplementary Note 10)

A matching system comprising:
a data acquisition device that acquires biometric information data on a person;
a storage device in which a plurality of biometric information data on a plurality of persons are registered; and
an information processing apparatus having a similarity calculation unit that calculates a similarity between the biometric information data acquired by the data acquisition device and the plurality of biometric information data registered in the storage device and a matching unit that, based on the similarity, determines whether or not a person indicated by the biometric information data acquired by the data acquisition device is a person registered in the storage device,
wherein the similarity calculation unit is further configured to calculate a similarity to test data including biometric information on the person for each of a plurality of registration candidate data each including biometric information on a single person, and
wherein the information processing apparatus further has a registration data selection unit that selects registration data to be registered in the storage device for matching the person out of the plurality of registration candidate data based on the similarity of each of the plurality of registration candidate data to the test data and a similarity to each of the plurality of biometric information data on the plurality of persons.

### (Supplementary Note 11)

An information processing method comprising:
for each of a plurality of registration candidate data including biometric information on a single person, calculating a similarity to test data including the biometric information on the person; and
selecting, as registration data to be registered in a data storage unit for matching the person, registration candidate data whose similarity to the test data is ranked high out of the plurality of registration candidate data.

### (Supplementary Note 12)

The information processing method according to supplementary note 11, wherein the selecting includes selecting the registration data based on the similarity to the test data and a similarity of each of the plurality of registration candidate data to each of a plurality of data including biometric information on a plurality of persons different from the person registered in the data storage unit.

### (Supplementary Note 13)

The information processing method according to supplementary note 12, wherein the selecting includes selecting, as the registration data, registration candidate data whose similarity to the test data is ranked high and which has a similarity higher than the similarity to the plurality of data out of the plurality of registration candidate data.

### (Supplementary Note 14]

The information processing method according to any one of supplementary notes 11 to 13, wherein the registration data is registration candidate data whose similarity to the test data is the highest out of the plurality of registration candidate data.

### (Supplementary Note 15)

The information processing method according to any one of supplementary notes 11 to 14, wherein the calculating includes calculating the similarity by using registration candidate data other than registration candidate data of interest as the test data for each of the plurality of registration candidate data.

### (Supplementary Note 16)

The information processing method according to any one of supplementary notes 11 to 14, wherein the calculating includes calculating the similarity by using each of all of registration candidate data other than registration candidate data of interest as the test data for each of the plurality of registration candidate data.

### (Supplementary Note 17)

The information processing method according to supplementary note 16, wherein the selecting includes selecting, as the registration data, registration candidate data whose similarity to registration candidate data other than registration candidate data of interest is the highest out of the plurality of registration candidate data.

### (Supplementary Note 18)

The information processing method according to supplementary note 17,
wherein the similarity corresponds to a matching score to the test data, and
wherein the registration candidate data whose similarity to the registration candidate data other than registration candidate data of interest is the highest is registration candidate data having the smallest sum of score ranks of the matching score to the registration candidate data other than the registration candidate data of interest.

### (Supplementary Note 19)

The information processing method according to supplementary note 17,
wherein the similarity corresponds to a matching score to the test data, and
wherein the registration candidate data whose similarity to the registration candidate data other than the registration candidate data of interest is the highest is registration candidate data having the largest sum of matching scores to the registration candidate data other than the registration candidate data of interest.

### (Supplementary Note 20)

A program that causes a computer to function as:
a unit that, for each of a plurality of registration candidate data each including biometric information on a single person, calculates a similarity to test data including the biometric information on the person; and
a unit that selects, as registration data to be registered in a data storage unit for matching the person, registration candidate data whose similarity to the test data is ranked high out of the plurality of registration candidate data.

### (Supplementary Note 21)

A computer readable storage medium storing the program according to supplementary note 20.

This application is based upon and claims the benefit of priority from Japanese Patent Application No. 2021-23824, filed on Feb. 18, 2021, the disclosure of which is incorporated herein in its entirety by reference.

### REFERENCE SIGNS LIST

100 information processing apparatus
110 image acquisition unit
120 matching score calculation unit
130 registration image selection unit
140 image registration unit
150 data storage unit
160 matching unit
200 processor
202 main storage unit
204 communication unit
206 input/output interface unit
208 system bus
210 output device
212 input device
214 storage device
300 capturing device
400, 700 storage device
500 information processing apparatus
510 similarity calculation unit
520 matching unit
530 registration data selection unit
600 data acquisition device
1000 authentication system

What is claimed is:

1. An information processing apparatus comprising:
a similarity calculation unit that, for each of a plurality of registration candidate data each including biometric information on a single person, calculates a similarity to test data including the biometric information on the person; and
a registration data selection unit that selects, as registration data to be registered in a data storage unit for matching the person, registration candidate data whose similarity to the test data is ranked high out of the plurality of registration candidate data.

2. The information processing apparatus according to claim 1,
wherein the data storage unit has a plurality of data including biometric information on a plurality of persons that are different from the person, and
wherein the registration data selection unit selects the registration data based on the similarity to the test data and a similarity of each of the plurality of registration candidate data to each of the plurality of data.

3. The information processing apparatus according to claim 2, wherein the registration data selection unit selects, as the registration data, registration candidate data whose similarity to the test data is ranked high and which has a similarity higher than the similarity to the plurality of data out of the plurality of registration candidate data.

4. The information processing apparatus according to claim 1, wherein the registration data is registration candidate data whose similarity to the test data is the highest out of the plurality of registration candidate data.

5. The information processing apparatus according to claim 1, wherein the similarity calculation unit calculates the similarity by using registration candidate data other than registration candidate data of interest as the test data for each of the plurality of registration candidate data.

6. The information processing apparatus according to claim 1, wherein the similarity calculation unit calculates the similarity by using each of all of registration candidate data other than registration candidate data of interest as the test data for each of the plurality of registration candidate data.

7. The information processing apparatus according to claim 6, wherein the registration data selection unit selects, as the registration data, registration candidate data whose similarity to registration candidate data other than registration candidate data of interest is the highest out of the plurality of registration candidate data.

8. The information processing apparatus according to claim 7,
wherein the similarity corresponds to a matching score to the test data, and
wherein the registration candidate data whose similarity to the registration candidate data other than registration candidate data of interest is the highest is registration candidate data having the smallest sum of score ranks of the matching score to the registration candidate data other than the registration candidate data of interest.

9. The information processing apparatus according to claim 7,
wherein the similarity corresponds to a matching score to the test data, and
wherein the registration candidate data whose similarity to the registration candidate data other than the registration candidate data of interest is the highest is registration candidate data having the largest sum of matching scores to the registration candidate data other than the registration candidate data of interest.

10. A matching system comprising:
a data acquisition device that acquires biometric information data on a person;
a storage device in which a plurality of biometric information data on a plurality of persons are registered; and
an information processing apparatus having a similarity calculation unit that calculates a similarity between the biometric information data acquired by the data acquisition device and the plurality of biometric information data registered in the storage device and a matching unit that, based on the similarity, determines whether or not a person indicated by the biometric information data acquired by the data acquisition device is a person registered in the storage device,
wherein the similarity calculation unit is further configured to calculate a similarity to test data including biometric information on the person for each of a plurality of registration candidate data each including biometric information on a single person, and
wherein the information processing apparatus further has a registration data selection unit that selects registration data to be registered in the storage device for matching the person out of the plurality of registration candidate data based on the similarity of each of the plurality of registration candidate data to the test data and a similarity to each of the plurality of biometric information data on the plurality of persons.

11. An information processing method comprising:
for each of a plurality of registration candidate data including biometric information on a single person, calculating a similarity to test data including the biometric information on the person; and
selecting, as registration data to be registered in a data storage unit for matching the person, registration candidate data whose similarity to the test data is ranked high out of the plurality of registration candidate data.

12. The information processing method according to claim 11, wherein the selecting includes selecting the registration data based on the similarity to the test data and a similarity of each of the plurality of registration candidate data to each of a plurality of data including biometric information on a plurality of persons different from the person registered in the data storage unit.

13. The information processing method according to claim 12, wherein the selecting includes selecting, as the registration data, registration candidate data whose similarity to the test data is ranked high and which has a similarity higher than the similarity to the plurality of data out of the plurality of registration candidate data.

14. The information processing method according to claim 11, wherein the registration data is registration candidate data whose similarity to the test data is the highest out of the plurality of registration candidate data.

15. The information processing method according to claim 11, wherein the calculating includes calculating the similarity by using registration candidate data other than registration candidate data of interest as the test data for each of the plurality of registration candidate data.

16. The information processing method according to claim 11, wherein the calculating includes calculating the similarity by using each of all of registration candidate data other than registration candidate data of interest as the test data for each of the plurality of registration candidate data.

17. The information processing method according to claim 16, wherein the selecting includes selecting, as the registration data, registration candidate data whose similarity to registration candidate data other than registration candidate data of interest is the highest out of the plurality of registration candidate data.

18. The information processing method according to claim 17,
wherein the similarity corresponds to a matching score to the test data, and
wherein the registration candidate data whose similarity to the registration candidate data other than registration candidate data of interest is the highest is registration candidate data having the smallest sum of score ranks of the matching score to the registration candidate data other than the registration candidate data of interest.

19. The information processing method according to claim 17,
wherein the similarity corresponds to a matching score to the test data, and
wherein the registration candidate data whose similarity to the registration candidate data other than the registration candidate data of interest is the highest is registration candidate data having the largest sum of matching scores to the registration candidate data other than the registration candidate data of interest.

20. A non-transitory storage medium storing a program that causes a computer to function as:
a unit that, for each of a plurality of registration candidate data each including biometric information on a single person, calculates a similarity to test data including the biometric information on the person; and
a unit that selects, as registration data to be registered in a data storage unit for matching the person, registration candidate data whose similarity to the test data is ranked high out of the plurality of registration candidate data.

21. (canceled)
